(19) United States
(12) Patent Application Publication
(10) Pub. No.: US 2016/0338394 A1
(43) Pub. Date: Nov. 24, 2016

(54) PROCESS FOR MAKING MEAT CHIPS

(71) Applicant: Eckkehard Willutzki, Lombard, IL (US)

(72) Inventor: Eckkehard Willutzki, Lombard, IL (US)

(21) Appl. No.: 15/213,457

(22) Filed: Jul. 19, 2016

Related U.S. Application Data
(63) Continuation-in-part of application No. 14/719,606, filed on May 22, 2015.

(51) Int. Cl. A23L 13/60

(52) U.S. Cl. CPC A23L 13/67; A23V 2002/00

(57) ABSTRACT

Processes for manufacturing meat chips including the steps of adding ice to meat, grinding the chilled meat to form a ground, chilled mixture; placing the ground, chilled mixture in forms; baking the mixture; removing the mixture from the forms; slicing the mixture; and dehydrating the slices to transform them into meat chips.

### CONTINUATION APPLICATION

This application is a continuation-in-part, and claims priority as to similar subject matter, from U.S. application Ser. No. 14/719,606, filed May 22, 2015, with the same title.

### BACKGROUND OF THE INVENTION

The present invention generally relates to processes for preparing meat. More specifically, the invention relates to a process for making meat chips.

The inventor is a butcher who is not currently aware of any repeatable processes for making edible, commercially acceptable, dehydrated meat chips from lean meat. The inventor discovered that meat, while about 70% water, can actually absorb much more water than that—even more water than its weight. By causing meat to absorb so much water, the meat expands, such that when it is cooked and then dried, it will provide a different, fluffier texture than it would otherwise have.

Additionally, the inventor accidently discovered that, counter-intuitively, the meat should not be “finished,” i.e., brought to 45° F., as it is for sausage, for example, to provide the dehydrated meat chips of the present invention. Instead, ice chips should always be present in the meat as it is placed in the oven for cooking, such that the meat is still at about 32° F. (the temperature of an ice-water bath) as it is placed in the oven. By ensuring the presence of ice in the meat mixture at the start of cooking, this ensures that the meat chips will have “holes” in them, which is desirable, texture-wise, for providing the dehydrated meat chips. The meat should be unfinished and not hold together as well as if it was used for sausage, for example; otherwise, it will not cook to a fluffy texture and then, when dehydrated, may become too hard, and will not easily crack like a potato chip, as desired.

Accordingly, it would be advantageous to provide a new process for treating meat, providing an advantageous texture for making meat chips.

### Definition of Claim Terms

The following terms are used in the claims of the patent as tiled and are intended to have their broadest meaning consistent with the requirements of law. Where alternative meanings are possible, the broadest meaning is intended. All words used in the claims are intended to be used in the normal, customary usage of grammar and the English language.

“Form” includes any forms or flexible shaping materials for forming or holding meat or meat mixtures, including but not limited to rigid metal or metallic forms, flexible casings, including animal-based casings, foil or plastic.

### SUMMARY OF THE INVENTION

The objects mentioned above, as well as other objects, are solved by the present invention, which overcomes disadvantages of prior meat preparation processes, while providing new advantages not previously obtainable with such processes.

One preferred embodiment of the present invention includes a process for making meat chips is provided, which includes chilling meat to about 32° F. by adding ice cubes to the meat, and then placing the chilled mixture into a food processor, for example. The weight of the ice may be about the same as the weight of the meat, or may vary by 80%-120% of the weight of the meat. After food processing, at least some ice chips (melted from ice cubes) should still be present, such that the chilled mixture is still about 32° F.; the chilled mixture may now be placed in forms (such as loaf or sausage-shaped forms, for example), and baked. Baking/cooking preferably continues until the inside temperature of the mixture reaches about 150° F., if baking powder is not used. Preferably, however, baking powder is used, to ensure that the meat mixture fluffs when cooked, in which case baking/cooking should continue until the internal temperature of the cooked meat reaches 180° F., to properly activate the baking power. After cooking, the mixture may be removed from the forms, sliced, and dehydrated. Dehydration may take place in a dehydrator or an oven, and continues until the meat slices become a chip with a desired crispy texture, so that it can be easily cracked, similar to the texture and consistency of a potato chip. As a non-limiting example, dehydration at 110° F.-120° F. may take about 6-8 hours, such as 7 hours, while dehydrating at temperatures greater than 120° F. will take substantially less time; again, time and temperature may be varied, but the crispy texture and consistency of a potato chip is the goal.

Preferably, the meat comprises a lean meat with less than 1% fat by weight, which may be lean meat from any animal, such as one or more of the following: chicken; venison or pork.

### DETAILED DESCRIPTION OF THE PREFERRED EMBODIMENTS

Set forth below is a description of what are believed to he the preferred embodiments and/or best examples of the invention claimed. Future and present alternatives and modifications to this preferred embodiment are contemplated. Any alternatives or modifications which make insubstantial changes in function, in purpose, in structure, or in result are intended to he covered by the claims of this patent.

Various processes for making meat chips may be employed within the spirit of the present invention. One such process is now described. To a lean meat, such as chicken breast, with less than or equal to about 1% fat, spices may be added, along with baking powder (e.g., about 30 grams of baking powder/kilogram of meat). The meat may now he ground in a meat grinder. In a particularly preferred process, ice cubes, in the approximate amount of the weight of the meat (80%-120%) may now be added to a food processor, such as a 2 hp or 3 hp Ninja meat food processor, or a Buffalo bowl-type cutter. Mixing within the food processor may occur for about 2 and ½-3 minutes, for example. After mixing in a food processor, for example, at least some ice chips should still be present within the chilled meat, such that the temperature of the chilled, unfinished meat should be about 32° F.

The mixture may now be placed in forms (such as loaf-shaped or sausage-shaped metallic form such as foil, for example), which have been preferably sprayed with butter or another greasing agent. The chilled mixture should still include at least some ice chips within the chilled meat, to ensure the meat is about 32° F. when it is placed inside the oven. Once inside the forms, if baking powder is used the internal temperature of the meat should be heated to about 180° F. to activate the baking powder, and then removed from the forms and sliced. Less preferably, if baking powder is not used, the internal temperature of the meat need only reach 150° F. before removal from heat.

After removal from the forms, the meat may be sliced to a desired form (such as in cylindrical slices of about ⅛-inches- 3/16-inches thick), and placed in a dehydrator oven for a substantial time period, until dried, crispy meat chips result. One preferred method of dehyrdration is using a dehydrator, at temperatures of about 110° F.-120° F., such as for about 6-8 hours, and most preferably about 7 hours, or until dried crispy meat chips result (which may be longer or shorter, depending on the size of the forms, the type of meat, etc.). With higher temperatures, less dehydrating time may be required. In any case, the slices should he dried to the texture and. consistency of potato chips.

In an alternative embodiment, instead of dehydrating the cooked meat slices, the cooked meat slices may he placed in as deep fryer and deep-fried until crispy.

Using the above-described techniques, various lean, meat-based products may be processed, made from any lean meat, including but not limited to chicken chips, pork chip and venison chips.

The above description is not intended to limit the meaning of the words used in the following claims that define the invention. For example, while various preferred and less preferred embodiments have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

We claim:

1. A process for making meat chips, comprising the steps of:
adding ice cubes to meat, and mixing the meat and the ice cubes, to form a chilled mixture;
placing the chilled mixture, with at least some ice chips still present, in forms, and cooking the mixture; and
removing the mixture from the forms, slicing the mixture, and dehydrating the slices to transform the meat slices into dried meat chips.

2. The process of claim 1, wherein the meat comprises a lean meat with less than 1% fat by weight.

3. The process of claim 1, wherein the ice cubes are added in an amount equal to about 80%-120% by weight of the meat.

4. The process of claim 1, further comprising the step of adding spices to the meat prior to mixing the meat and the ice cubes.

5. The process of claim 1, further comprising the step of adding baking powder to the meat prior to dehydrating or cooking the mixture.

6. The process of claim 5, wherein about 30 grams of baking powder is added for each kilogram of meat.

7. The process of claim 1, wherein the meat comprises any lean meat.

7. process of claim 7, wherein the lean meat comprises chicken, venison or pork.

9. The process of claim 1, wherein the mixture is cooked until the inside temperature of the mixture reaches about 150° F.

5. The process of claim 5, wherein the mixture is cooked until the inside temperature of the mixture reaches about 180° F.

11. The process of claim 1, wherein the slices are dehydrated until the slices become meat chips with a crispy texture.

12. The process of claim 1, wherein a greasing agent is placed on the inner surface of the forms prior to adding the chilled mixture to the forms.

13. A process for making meat chips, comprising the steps of:
adding ice cubes to meat, and mixing the meat and the ice cubes, to form a chilled mixture;
placing the chilled mixture, with at least some ice chips still present, in forms, and cooking the mixture; and.
removing the mixture from the forms, slicing the mixture, and deep frying the slices to transform the meat slices into fried meat chips.
